(19) United States
(12) Patent Application Publication
(10) Pub. No.: US 2004/0042724 A1
(43) Pub. Date: Mar. 4, 2004

(54) Method and device for producing a coupling grating for a waveguide

(76) Inventors: Andreas Gombert, Freiburg (DE); Michael Niggemann, Freiburg (DE); Hansjorg Lerchenmuller, Freiburg (DE)

Correspondence Address: BREINER & BREINER, 115 NORTH HENRY STREET, P. O. BOX 19290, ALEXANDRIA, VA, 22314, US

(21) Appl. No.: 10/415,469

(22) PCT Filed: Aug. 24, 2001
(86) PCT No.: PCT/DE01/03351

(30) Foreign Application Priority Data
Nov. 29, 2000 (DE) 100 59 268.6

(51) Int. Cl. G02B 6/34

(52) U.S. Cl. 385/37

(57) ABSTRACT

The invention relates to a method and a device for producing a coupling grating (5) for a waveguide. The method relies on the technique of interference lithography, whereby an interference pattern on a light-sensitive layer (2) is exposed by superimposing two coherent light beams (3, 4) on said light-sensitive layer (2). Said pattern is then transferred onto the surface of the substrate (1) that lies underneath by subsequent developing and an etching process. The method is characterized in that it uses a shadow mask (6) that is mounted at minimum clearance relative to the surface of the light-sensitive layer (2). By observing said minimum clearance, the Fresnel diffraction images of both light beams (3, 4) are separated on the edge(7). The thickness of the light-sensitive layer (2) is selected in such a way that the superimposition of the Fresnel diffraction pattern of one light beam with the other undisturbed light beam suffices to uncover areas of the substrate (1) during subsequent developing of the layer (2). The method makes it possible to avoid transfer of unwanted diffraction effects on the edge of the shadow mask to the substrate. The method provides a cost-effective solution for the production of large-surface coupling grating matrices.

### FIELD OF APPLICATION

The present invention relates to a method for producing a coupling grating for a wavequide utilizing interference lithography, in which a light-sensitive layer on a substrate is exposed with an interference pattern produced by superimposing two coherent light beams and subsequently developed. The areas of the substrate that development laid bare undergo an etching process after which the light-sensitive layer is removed from the substrate. Furthermore, the invention relates to a device for carrying out the method.

Using coupling gratings to couple radiation into waveguides, particularly in integrated optical waveguides, is widespread. For example coupling gratings are produced on the surface of a glass substrate and the waveguide is applied to this structure as a highly diffracting layer. Typical grating periods for coupling gratings for coupling in visible light range from 300 to 1000 nm. The depth of the structure in the surface of the substrate, however, is usually less than 40 nm.

Many applications of integrated optical components respectively waveguides are in telecommunications and in sensor technology, which utilize that the evanescent field of the mode guided in the waveguide can assume a sensor function. In the same manner, the coupling grating itself can be utilized as a sensor element. For example, WO 95/03538 describes a biosensor matrix in microtiter plate format in which the coupling grating is employed as a sensor element. The microtiter plate having up to 96 wells described therein is provided with up to 4 coupling gratings per well, equivalent to a total of 384 coupling gratings on this component. If one assumes an average surface of 1 mm² per coupling grating, an area with a total of 384 mm² has to be provided with submicrostructures to produce this biosensor matrix. As a sensor matrix is a consumer product, to realize such an application, substrates structured with large-surface, defined coupling gratings must be produced in large numbers. Therefore, for this and similar applications, it is desirable to be able to produce cost-effective grating structures. However, particularly for high quality substrate materials, there is hitherto no cost-effective production of grating structures available.

For applications in which the coupled-in wave is led over a certain spatial area and then coupled out again via a second coupling grating, the quality of the junctions from the coupling grating to the unstructured area and the quality of the surface of the unstructured area are of essential significance for dampening the guided radiation and therefore for the number of evaluable signals. In many cases it is therefore additionally required that structuring of the substrate in well-defined regions for producing the coupling gratings does not lead to influencing respectively impairing wave guidance in the unstructured areas of the substrate.

### DESCRIPTION OF THE PRIOR ART

Various methods are presently used to produce coupling gratings for integrated optical components.

One such method that is frequently employed uses photolithographic technology to produce an etching mask for producing grating structures. In this method, photoresist is applied to the surface of the to-be-structured substrate, for example a glass substrate. Before carrying out the method, an exposure mask is produced for the photoresist by means of electron beam writing which provides the to-be-produced grating structure. This exposure mask is pressed against the substrate coated with the photoresist. In the subsequent exposure step using UV radiation, the radiation is impinged only on the regions of the photoresist not covered by the exposure mask. In the subsequent developing process, the solubility rate of the photoresist in the exposed regions differs significantly from that in the unexposed regions. If the resist is positive, the exposed regions dissolve faster; if the resist is negative, the unexposed ones are faster. Developing the exposed photoresist layer yields a surface relief that, upon suited selection of the exposure and developing parameters, masks the substrate where the lamella of the grating are and lays bare where the channels of grating are. After this the regions of the substrate laid bare in this manner are etched using a wet chemical process or an ion etching process. Following removal of the photoresist, the substrate is structured according to the desired coupling grating and can be coated with a waveguide.

However, this prior art contact method of exposure has the disadvantage that it cannot be used industrially for grating periods of <2 μm, because the production rejects due to unavoidable variations in the distance between mask and the substrate with small grating periods would be too high. With this method, the production of grating periods of <500 nm is not reproducible even in laboratory conditions.

Another drawback of this contact exposure method is that the writing time of the electron-beam writer for the exposure mask is approximately 1h/mm², thus very high. The production of an exposure mask for grating structures with periods of <1000 nm on areas of more than 50 mm² would require writing times of approximately 50 hours so that the costs, in particular for small-scale production, would be unacceptable.

Although, to avoid these drawbacks, a projection method of exposure can be employed to expose the photoresist. In this case, the exposure mask is usually projected smaller onto the photoresist layer with a scale of 5:1 (mask to image). The entire substrate is exposed by multiple application of the same pattern on the mask in a step-and-repeat process. Projection exposure has the advantage that grating periods of about 500 nm in the photoresist layer can also be produced industrially. However, this requires a projection exposure machine with exposure wavelengths in the low UV range. Such exposure machines are so expensive that their depreciation makes up a major part of the structuring costs. Consequently, this method is presently not implemented in industry.

Another disadvantage of this method is that projection exposure requires extremely plane substrates due to the low depth of sharpness of the image, which is usually only obtained by means of expensive surface processing procedures such as lapping and polishing. These requirements raise the costs for the usable substrates additionally.

Another prior art method for producing coupling gratings for integrated optical waveguides utilizes interference lithographic technology. In this method, the grating structures in the photoresist are produced by means of the interference of two superimposed coherent wavefields. Period Λ of the grating results in the following relationship upon symmetric incidence of the two waves:

$$Λ = \frac{{λ}_{0}}{2 sin {θ}_{i}}$$

with λ₀ standing for the wavelength of the coherent wavefields and θᵢ standing for the angle of incidence of the two wavefields. The spatial intensity modulation produced by the superimposition of the two wavefields on the surface of the photoresist leads to a structured exposure of the photoresist without needing to employ a complicated structured exposure mask. The grating period can be controlled in a simple manner via the angle of incidence of the two wavefields. To set the outer boundary of the grating on the substrate, only a masking layer with a mask opening setting this boundary is placed on the surface of the photoresist before exposure. This mask only sets the outer boundary of the coupling grating so that no complicated electron-beam writing is required.

An example of applying interference lithography technology for producing a coupling grating is described in U.S. Pat. No. 5,675 691. However the method disclosed there does not use a photoresist. But rather, the coupling grating is produced by means of laser ablation on the surface of a corresponding layer on a substrate. In this method, a refraction index variation is produced directly in the layer by modulating the spatial intensity of the irradiated and superimposed UV radiation.

Setting the spatial boundaries of the grating structure is very difficult when employing interference lithography technology to produce coupling gratings for waveguides. The state of the art approach for setting the boundaries of this grating structure by placing on the substrate a mask that limits the radiation field leads to diffraction effects at the edges of this mask. These diffraction effects for their part crop up again in the produced grating structure and influence it negatively.

Another prior art method for producing coupling gratings is utilizing replication processes. In these replication processes, first a model respectively a mold of the grating is produced as a surface relief and is multiplied by means of such methods such as imprinting or pouring. However, one of the methods described in the preceding is required to produce the model. The coupling grating is then produced, for example by imprinting the model into a plastic substrate, into sol-gel layers on the substrate or directly into glass.

An example of applying a replication method for producing coupling gratings is known from R. E. Kunz et al's, “Sensors and Actuators” A 46-47 (1995), pages 482 to 486. With the method employed there, the photolithographic model is created with the aid of an exposure mask produced by means of electron-beam writing so that the same drawbacks occur as already explained in connection with this method of production.

However, further difficulties arise when utilizing the replication method, which promises large piece numbers at lowest cost. Thus, although in plastics there are numerous form-giving processes available such as for example injection molding, high-grade waveguide layers with dampening values such as are realizable on glass cannot be produced on the available plastics. When using sol-gel layers on glass such as in direct imprinting of glass, the difficulties lie in imprinting large surfaces. Qualitatively, replicated coupling gratings are generally poorer than etched gratings. Due to the high investment costs, the prior art replication methods can also only be produced cost-effectively if the piece numbers are very high.

Based on this prior art, the object of the present invention is to provide a method and a device which permit producing high-grade coupling gratings for waveguides and are realizable cost-effectively.

### SUMMARY OF THE INVENTION

The object of the invention is solved using the method and the device according to claims 1 and 10. Advantageous embodiments of the method and of the device are the subject matter of the subclaims.

In the present method, a substrate having a light-sensitive layer, in particular a photoresist layer, applied onto it is provided. Structuring the layer occurs utilizing interference lithography. For this purpose two coherent light beams are superimposed to produce an interference pattern on the surface of the light-sensitive layer. The incidence angle of the two coherent light beams is selected in a state-of- the-art manner in order to be able to produce the desired grating period Λ on the surface. After exposure of the light-sensitive layer, it is developed in order to be able to lay bare or almost lay bare the corresponding regions of the substrate lying beneath as already explained in the introductory part hereof. For etching the substrate, the light-sensitive layer does not have to lay the substrate completely bare at the respective areas (grating channels), because a still remaining thin layer can also be etched through by means of a dry etching process. Dry-chemical or wet-chemical etching of the laid bare or nearly laid bare regions follows developing, with the structured light-sensitive layer serving as an etching mask. Suited wet-chemical etching processes for the respective substrate material, such as for example glass, are known to someone skilled in the art. The same applies to dry-etching processes, such as sputter etching or reactive ion etching. The etching process etches the grating structures into the substrate required for the function of the coupling grating. Finally the light-sensitive layer is removed so that the entire substrate surface with the etched-in grating structure is laid bare. Following removal of the light-sensitive material, the substrate can be coated with a higher refractive layer as the waveguide.

Preferably, with the present method a single coupling grating is not produced on a substrate but rather a plurality of coupling gratings is simultaneously produced in a matrix pattern on the substrate.

What distinguishes the present method is that the spatial boundaries of the single coupling gratings are realized by means of shadow masks, whose mask opening provides the typical rectangular respectively slot-shaped geometry of coupling gratings. An element of the present invention is that the shadow mask is positioned at a minimum distance to the surface of the light-sensitive layer, permitting separation of the two Fresnel diffraction images of the edges of the shadow mask running parallel to the grating lines. The two diffraction images result from the different incident directions of the two light beams.

It was understood that usually only the lateral boundary of the grating, which lies parallel to the grating channels, is important for coupling in a planar waveguide. The propagation direction of the guided mode is usually perpendicular or almost perpendicular to the grating channels respectively grating lines. The quality of the grating at the edges, which lie perpendicular to the grating lines, is therefore usually of less significance.

The present invention permits using slit-shaped or slot-shaped shadow masks, because the diffraction effects at the edges, which lie parallel to the grating channels, do not disturb the grating when exposure is carried out according to the present method.

Due to the minimum distance between the shadow mask and the light-sensitive layer, different exposure regions are produced in the junction between the grating structure and the unstructured surface. These regions result from the Fresnel diffraction images of the edge, which are imaged at different areas in the photoresist due to the different propagation directions of the two light beams used for interference lithography. In a first region, the two light beams are superimposed without disturbance and the desired photoresist grating structure develops. In the second region, the Fresnel diffraction image produced by the first light beam superimposes with the largely undisturbed second light beam. Due to the intensity variation of the first light beam, the contrast of the interferogram hardly changes. The grating structure is therefore imaged in the photoresist largely undisturbed in this second region. In the third region, the intensity of the light wave of the first light beam, and therefore also the structure depth of the grating, continues to diminish. With suitable selection of the starting thickness of the resist layer, the remaining thickness of the resist suffices in this region to prevent etching the substrate in the subsequent etching processes. Exposure and subsequent developing does therefore not lay the substrate bare nor almost lay it bare in this third region. In the fourth region, the intensity of the first wave is diminishingly small and only the projected Fresnel diffraction image of the second light beam is imaged in the photoresist. In the fifth region, the intensity of the wave of the second light beam continuously diminishes. Therefore, after developing, a sufficient thickness of the resist also remains in the fourth and fifth regions to prevent etching the substrate in the subsequent etching processes.

The inventors understood the factual situation of maintaining a minimum distance between the shadow mask and the surface of the light-sensitive layer and utilized it in the present method to obtain the desired boundaries of the coupling grating. For this purpose, the thickness of the light-sensitive layer respectively of the photoresist in compliance with the other exposure parameters, such as intensity of the coherent light beams and exposure time, is selected in such a manner that exposure only in the intensity maxima in the first and second region suffices to lay the substrate lying beneath after development bare or almost bare. The disturbing diffraction effects caused by the edges of the shadow mask, which primarily crop up in the third and fifth regions, are transferred into the photoresist mask but not onto the substrate and therefore not into the coupling grating.

The required minimum distance between the mask and the substrate, which leads to the invented separation of the diffraction images, can be estimated as follows. A semi-finite plane lies in a plane formed by the orthogonal x and y axes. In the event of a planar incident wave, a non-dimensional parameter w is determined as follows when observing the distribution of the intensity along a line in x direction perpendicular to the edge running in y direction:

$$w = \sqrt{\frac{2}{λ d}} \cdot Δ {x}_{1}$$

with d standing for the distance between mask and the photoresist-coated substrate (cf., e.g. Klein, M. V., Furtak, T. E., Optik, Springer-Verlag (1988).

Separation of the two diffraction figures is yielded by the geometry of the incident waves:

Δx₂=2tan θᵢ·d.

The distance Δx₂ should be greater than the extension Δx₁ of the Fresnel diffraction image at a certain minimum value of w. One therefore finds the following inequation for the required distance between the mask and the substrate:

$$d \geq \frac{{w}^{2}}{8 {tan}^{2} {θ}_{i}} \cdot {λ}_{0} \qquad with {θ}_{i} = {sin}^{- 1} ( \frac{{λ}_{0}}{2 Λ} )$$

Tests showed that a separation of the diffraction images for w=4 or greater suffices to produce etching masks in the photoresist for troublefree coupling gratings.

The required minimum distance dₘᵢₙ between the shadow mask and the photoresist-coated substrate is therefore preferably yielded by:

$${d}_{min} = \frac{2}{{tan}^{2} {θ}_{i}} \cdot {λ}_{0} \qquad with {θ}_{i} = {sin}^{- 1} ( \frac{{λ}_{0}}{2 Λ} )$$

The two light beams do not necessarily have to hit the layer symmetrically at the same angle θᵢ to the surface normals. The minimum distance yielded with varying incident angles can be determined analogue to the above estimation. Alternatively, an angle averaged from the incident angles of the two light beams can also be used in the above formula.

The invented method permits producing single coupling gratings or an entire coupling grating matrix in an advantageous, cost-effective manner on a large substrate surface. Exposure masks, which have to be produced by a time-consuming electron-beam writing process, are no longer required for producing coupling gratings. Furthermore, the problems of disturbing diffractions at the edges in producing coupling gratings known from interference lithography are avoided. Disturbance from the unstructured regions between the coupling gratings does not occur in the present method.

The respective device comprises a holding means for the substrate and the exposure mask used to set the boundaries of the coupling grating. Spacers ensuring the maintenance of the minimum distance between the mask and the substrate can be employed between the exposure mask and the surface of the light-sensitive layer. Furthermore, the device comprises a coherent laser light source having respective beam splitting and beam widening optics as well as beam guiding elements to be able to irradiate the laser beams onto the surface of the substrate at defined incident angles. The mask used is provided with cutting-edge-shaped mask openings with edges running perpendicular to the plane formed by the laser beams, i.e. parallel to the to-be-produced grating lines.

The angle α of the cutting edges is selected in dependence of the incident angle θᵢ of the laser beams preferably according to the following relationship:

θᵢ+2α≦90°.

Due to this selection of the cutting-edge angle, the waves reflected on it are not deflected onto the substrate coated with the photoresist so that additional disturbances due to reflection are avoided.

The mask itself can also be formed by means of one or multiple slit-shaped openings without lateral boundaries. This then suffices if the coupling gratings are to extend over the entire width of the substrate. However, in the case of a plurality of adjacent coupling gratings, the mask openings are provided with lateral boundaries, thus are rectangular in shape, with the length of these rectangular slots being much greater than its width corresponding to the typical shape of a coupling grating.

In an advantageous preferred embodiment, the device comprises in addition a special holding means for the exposure mask having a drive with which the mask can be moved perpendicular to the substrate surface along a defined path during exposure while maintaining the minimum distance. This embodiment of the device relates to a particular embodiment variant of the present method in which the distance between the exposure mask and the surface of the light-sensitive layer is altered during the exposure time. This alteration, which can be realized for example by a simple linear movement of the exposure mask perpendicular to the surface of the substrate, results in averaging the Fresnel diffraction images at different sites and thus in a reduction of the contrast of the Fresnel diffraction images. This reduction of the contrast leads to a further reduction of the disturbing diffraction effects in producing coupling gratings. The dimensions of the setting range of the exposure mask is dependent on the to-be-produced grating period. The greater the grating period the larger the setting range must be selected in order to achieve adequate averaging.

### A BRIEF DESCRIPTION OF THE DRAWINGS

The present method is briefly described once more in the following using preferred embodiments with reference to the accompanying drawings without the intention of limiting the scope or spirit of the inventive idea.

FIG. 1 shows a schematic representation of an example of the irradiation of two coherent light beams onto the surface of a substrate layer to produce an interference pattern;

FIG. 2 shows an exemplary representation of the conditions at an edge of the exposure mask in the present method;

FIG. 3 shows a scanning electron microscope image of a photoresist structure exposed according to the present method.

FIG. 4 shows an enlarged detail of the structure of FIG. 3;

FIG. 5 shows an example of a substrate structured using a coupling grating matrix according to the present invention; and

FIG. 6 shows an example of the respective exposure mask for producing the coupling grating matrix according to FIG. 5.

### WAYS TO CARRY OUT THE INVENTION

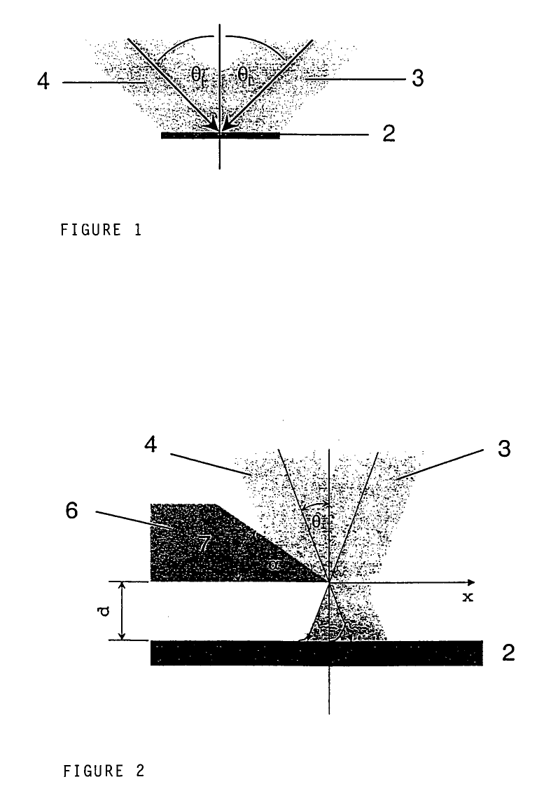

FIG. 1 shows a schematic representation of an example of the exposure of the surface of a light-sensitive layer 2 with two coherent light beams 3,4. Both the light beams are superimposed at a fixed angle of θᵢ on the surface of the light-sensitive layer 2. This representation shows neither the substrate on which the light-sensitive layer is applied nor the exposure mask to set the boundaries of the to-be-produced coupling grating. The wavelength λ₀ of the two irradiated light beams and the incident angle θᵢ yield a fixed spatial intensity modulation having a period of Λ which corresponds to the to-be-produced grating period.

In the present example, a coupling grating matrix having a grating period of Λ=500 nm should be produced. For this purpose, an argon ion laser having an emission wave length of 364 nm is employed. The output beam of this laser is split into two partial beams, which are widened using corresponding optics and irradiated onto the light-sensitive layer 2, a photoresist layer at an angle of θᵢ=21.3°. The exposure time for producing such a type coupling grating matrix is dependent on the intensity of the irradiated laser radiation and the properties of the photoresist layer. In the present case, an exposure time of 1 to 2 minutes is required. The exposure time is set by at least one shutter in the radiation path of the laser so that if the radiation strength is given, the exposure dose is fixed.

FIG. 2 shows an exploded view of the conditions during exposure. The figure shows once more the light-sensitive layer 2 and the two laser light beams 3 and 4 superimposed at an angle of θᵢ. Furthermore, this figure also shows an inner border respectively an inner edge 7 of the mask opening of the exposure mask 6 utilized as a shadow mask. In the present example, the mask comprises a metal plate having a thickness of at least 1 mm to prevent distortion. The mask openings are preferably made by means of ultra-precision processing using diamond tools to obtain optical surfaces, which are necessary to avoid scattering waves when exposing the photoresist. The mask openings are executed as slot openings whose shape corresponds to the outer outline of the to-be-produced coupling grating matrix. To produce the desired coupling grating matrix, the slot-shaped mask openings are distributed evenly over the metal plate. The edges of the slots, which lie parallel to the to-be-produced grating channels, are executed as cutting edges 7 as FIG. 2 shows. The effect of the cutting edge is that with a suited selection of the cutting-edge angle α, the waves reflected thereon cannot hit the substrate coated with the photoresist 2. The angle α of the cutting edge 7 is selected dependent on the incident angle θᵢ according to θᵢ+2α≦90°.

During exposure, a holding means is employed which permits reception of the shadow mask 6 and the glass substrate (not depicted here) coated with the photoresist 2. A mechanical spacer, also not depicted in FIG. 2, ensures the, according to the invented method, to-be-maintained minimum distance d.

FIG. 2 distinctly shows the separation of the two Fresnel diffraction images of the two coherent light beams 4 and 5 on the surface of the light-sensitive layer 2. The intensity distribution of these diffraction images is indicated schematically in the figure. This separation of the two diffraction patterns leads to the already described five exposure regions on the light-sensitive layer.

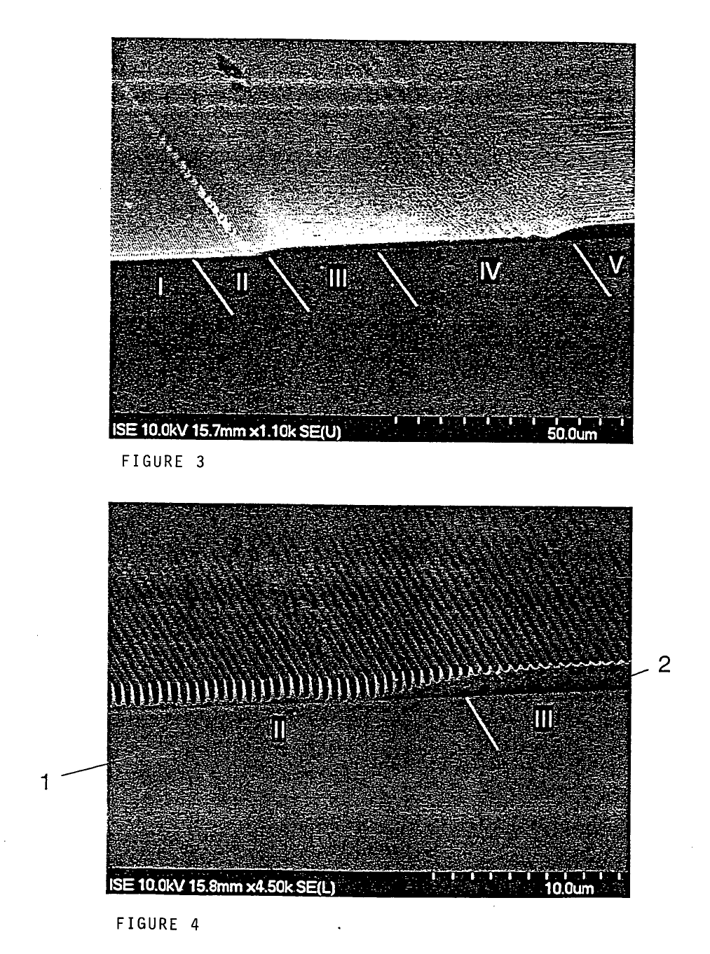

These five regions (designated with Roman numerals) are shown again in the following FIGS. 3 and 4 using a scanning electron microscopic image of a substrate 1 with a photoresist layer 2 exposed according to the present method. In FIGS. 3 (and 4), the photoresist 2 is applied thicker than usual in order to make the effects produced with the present method more apparent. The differences between the exposure regions I to V after development of the photoresist using a conventional developer are quite distinct. The minimum distance between the mask and the surface of the photoresist layer and the resulting separation of the diffraction images permits preventing the diffraction images of the regions III to V from being exposed down to the substrate as the remaining resist thickness in region III after development shows very well in FIG. 4. However, disturbances occur particularly in the regions II to V and therefore are not transferred onto the substrate 1 during the etching process. In the regions I and II, the intensity suffices to completely remove the photoresist at the intensity maxima of the interference pattern during development and the grating lines are completely transferred onto the substrate 1. On the other hand however, the disturbance due to the diffraction effects is negligibly small in these regions so that no disturbance of the grating occurs during transference of the photoresist structure onto the substrate beneath. The disturbances seen in FIGS. 3 and 4 are due to the greater resist thickness selected for better illustration.

In this example, the transference of the grating structure onto the substrate is carried out by means of a subsequent wet-chemical etching process using HF occurring in the regions laid bare by developing the photoresist. Grating channels are also produced here by etching in the glass substrate 1.

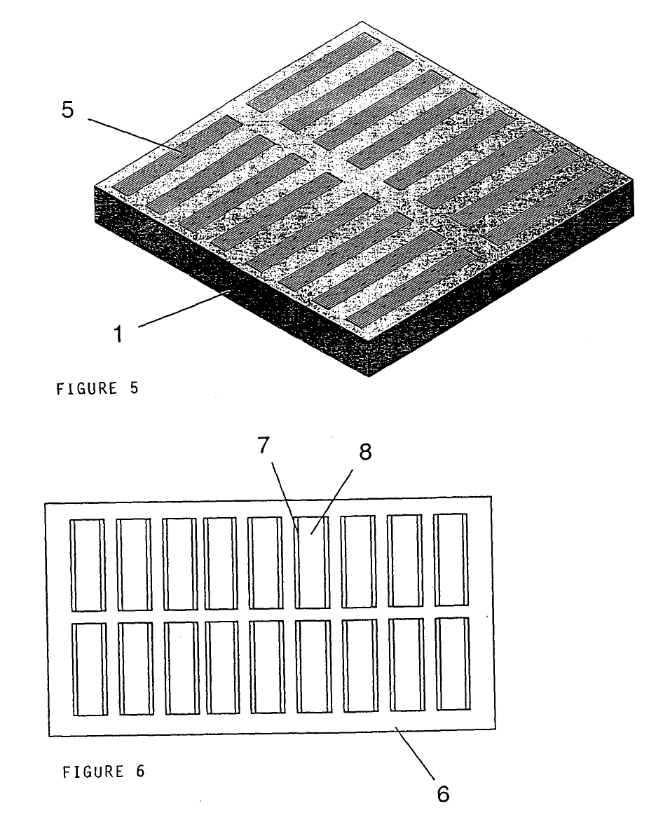

Following the etching step, the photoresist can be removed with a solvent, commercial photoresist stripper or by means of O₂ plasma treatment. A coupling grating matrix such as the one shown in the example in FIG. 5 (not to scale) remains on the substrate 1. The individual coupling gratings 5 are easily distinguishable as matrix-like arranged structured regions on the substrate 1. In this example of exposure using an argon ion laser to produce a grating period of 500 nm, a distance of 20 μm is selected as the distance between the exposure mask 6 and the surface of the photoresist 2. Taking the required separation of the diffraction images of the two split beams 3, 4 into consideration, maintaining a minimum distance of about 5 μm in this case would however also lead to a satisfactory result.

With the present method, for example approximately 10 coupling gratings with outer dimensions of 1 mm×10 cm or approximately 100 coupling gratings with outer dimensions of 1 mm×10 mm in matrix form are produced on a microtiter plate with the dimensions 8×12 cm by means of one exposure. It is a matter of course that the coherent split beams have to be widened accordingly in a large-surface manner.

Furthermore, someone skilled in the art is familiar with the fact that in order to produce other grating periods other incident angles, exposures times and distances from the exposure mask to the substrate surface have to be selected. For expedience, however the distance from the exposure mask to the surface of the light-sensitive layer 2 does not exceed a value of 3 cm.

Finally, FIG. 6 shows a top view of an example of a shadow mask for exposure of a structure like the one in FIG. 5. The individual slot-shaped mask openings 8 are not depicted to scale. The cutting-edge-like design of the edges 7 of these mask openings is also shown schematically. The edges of the narrow boundaries of the mask openings have a different shape in order to prevent possible reflections. These edges are preferably undercut.

In another preferred embodiment of the method, the mask 6 is, in addition, moved linearly and perpendicular to the surface of the substrate during exposure. In this example, a movement of 20 μm during an exposure period of two minutes suffices to yield the desired averaging of the Fresnel diffraction images. Such a linear movement can, for example, occur by means of a piezo drive. Another manner of moving the mask to cover this region can, of course, also be realized.

The shadow mask 6 can, of course, also be realized in other fashions. For example, two metal sheets mounted in the same plane can form a slot which sets the boundary of the coupling grating in one dimension. This embodiment is especially suited for gratings stretching over the entire to-be-used width of the substrate. The edges of the metal sheets are again designed as cutting-edges by means of polishing and grinding.

Furthermore, a chrome mask on a glass support, such as is used in microlithography, can be utilized as the shadow mask. In this example, however, an AR coating of the glass support, which is optimized for polarization and the incident angle of the incident beams, is required to suppress undesired interferences.

### LIST OF REF R NCE NUM RALS

1 substrate

2 light-sensitive layer, photoresist

3, 4 coherent light beams

5 coupling grating

6 shadow mask respectively exposure mask

7 cutting-edge-like edges

8 mask openings

What is claimed is:

1. A method for producing a coupling grating for a waveguide utilizing interference lithography, in which a light-sensitive layer (2) on a substrate (1) is exposed with an interference pattern by superimposing two coherent light beams (3,4) and said light-sensitive layer (2) is subsequently developed, the regions of said substrate (1) which said development laid bare or nearly laid bare are subjected to an etching process and said light-sensitive layer (2) is then removed from said substrate,
wherein,
to set the outer boundaries of said to-be-produced coupling grating (5) during said exposure, a shadow mask (6) is disposed while maintaining a minimum distance dₘᵢₙ from the surface of said light-sensitive layer (2), said distance permitting a spatial separation of the Fresnel diffraction patterns of the two light beams (3,4) on the surface due to an inner edge (7) of said shadow mask (6), with the thickness of said light-sensitive layer (2) being selected in such a manner that said superimposition of said Fresnel diffraction pattern of one said light beam with the undisturbed other said light beam (3,4) for exposure of said light-sensitive layer (2) just suffices to be able to etch regions of said substrate (1) following said subsequent development of said layer (2).

2. A method according to claim 1,
wherein,
said minimum distance dₘᵢₙ is selected in such a manner that the relationship
$${d}_{min} \geq \frac{2}{{tan}^{2} {θ}_{i}} \cdot {λ}_{0}$$
is fulfilled, with λ₀ standing for the central wavelength and θᵢ for the, if required averaged, angle of incidence of said two light beams.

3. A method according to claim 1 or 2,
wherein,
a photoresist layer is utilized as said light-sensitive layer (2).

4. A method according to one of the claims 1 to 3,
wherein,
said distance of said shadow mask (6) from said surface of said light-sensitive layer (2) is altered during said exposure of said layer (2).

5. A method according to one of the claims 1 to 4,
wherein,
a shadow mask (6) having one or a plurality of slot-shaped mask openings (8) is utilized.

6. A method according to one of the claims 1 to 5,
wherein,
a shadow mask (6) is utilized whose inner edges (7), which are to effect setting the boundaries of said coupling grating parallel to the grating lines, are designed as cuttings edges having a cutting angle α in relation to a main surface of said shadow mask, said cutting angle fulfilling the condition θᵢ+2α≦90°, with θᵢ being the angle of incidence of the two light beams.

7. A method according to one of the claims 1 to 6,
wherein,
using a shadow mask (6) having a plurality of mask openings (8) disposed in a matrix manner produces a multiplicity of coupling gratings simultaneously on said substrate (1).

8. A method according to one of the claims 1 to 7,
wherein,
following removal of said light-sensitive layer (2) the substrate is coated with a waveguide layer the refraction index of which is higher than that of said substrate (1).

9. A method according to one of the claims 1 to 7,
wherein,
the substrate having one or a plurality of coupling gratings is utilized as an imprinting mask for producing further coupling gratings.

10. A device for carrying out the method according to one or a multiplicity of the preceding claims having a holding means for a substrate (1), a shadow mask (6), which can be set at a defined distance from the surface of a substrate (1) inserted in said holding means, as well as a source of coherent laser light having a beam splitting and beam widening optic as well as beam guiding elements in order to be able to superimpose two split beams (3, 4) at defined angles of incidence on the surface of a substrate (1) inserted in said holding means, with said shadow mask (6) being provided with mask openings (8) having edges (7) running perpendicular to the plane formed by said split beams (3, 4) and which are designed in a cutting-edge manner.

11. A device according to claim 10,
wherein,
a drive is provided with which said shadow mask (6) is moved perpendicular to the substrate surface during exposure.

12. A device according to claim 10 or 11,
wherein said shadow mask (6) is provided with one or a plurality of slot-shaped mask openings (8).
